(19) United States
(12) Patent Application Publication
(10) Pub. No.: US 2022/0008906 A1
(43) Pub. Date: Jan. 13, 2022

(54) Semiconductor Optical Electrode

(71) Applicant: Nippon Telegraph and Telephone Corporation, Tokyo (JP)

(72) Inventors: Yuya Uzumaki, Musashino-shi, Tokyo (JP); Sayumi Sato, Musashino-shi, Tokyo (JP); Yoko Ono, Musashino-shi, Tokyo (JP); Takeshi Komatsu, Musashino-shi, Tokyo (JP)

(21) Appl. No.: 17/292,682

(22) PCT Filed: Nov. 20, 2019
(86) PCT No.: PCT/JP2019/045341

§ 371 Date: May 10, 2021

(30) Foreign Application Priority Data
Dec. 4, 2018 (JP) 2018-227076

(51) Int. Cl. B01J 35/00; B01J 37/02; C25B 11/053; B01J 23/42; B01J 23/755; C25B 1/55

(52) U.S. Cl. CPC B01J 35/004; B01J 37/024; C25B 11/053; C25B 1/02; B01J 23/755; C25B 1/55; B01J 23/42

(57) ABSTRACT

Provided is a semiconductor photoelectrode which maintains a light energy conversion efficiency for a long time. In the semiconductor photoelectrode, using a conductive substrate including a III-V group compound semiconductor, a semiconductor thin film including a III-V group compound semiconductor having a photocatalytic function is disposed on the substrate, and an oxygen generation co-catalyst layer having an oxygen generation co-catalytic function for the semiconductor thin film is disposed on the semiconductor thin film. Between the semiconductor thin film and the oxygen generation co-catalyst layer, a semiconductor thin film including a III-V group compound semiconductor having a lattice constant smaller than that of the semiconductor thin film in a plane perpendicular to a crystal growth direction is disposed.

### TECHNICAL FIELD

The present invention relates to a semiconductor photoelectrode having a photocatalytic function that exhibits a catalytic function by light irradiation to cause a chemical reaction of an oxidation or reduction target substance.

### BACKGROUND ART

Some photocatalysts are known to exhibit catalytic function by light irradiation to cause chemical reactions of an oxidation or reduction target substance. For example, photocatalysts that can generate hydrogen from water without development of carbon dioxide by using sunlight or the like is drawing attention, and have been actively studied in recent years. Using a semiconductor photoelectrode that is an electrode made by connecting a lead to a semiconductor thin film that exhibits a catalytic function by light irradiation, water is decomposed by irradiating the semiconductor photoelectrode with light.

The decomposition reaction of water using a photocatalyst consists of an oxidation reaction of water and a reduction reaction of protons. When the n-type photocatalyst material is irradiated with light, electrons and holes are generated and separated in the photocatalyst. The holes move to the surface of the photocatalyst material and contribute to the oxidation reaction of water. On the other hand, the electrons move to the reduction electrode and contribute to the reduction reaction of protons. Ideally, such a redox reaction proceeds and a water splitting reaction occurs.

Oxidation reaction: 2H₂O+4h⁺→O₂+4H⁺

Reduction Reaction: 4H⁺+4e⁻→2H₂

FIG. 4 shows a semiconductor photoelectrode in the related art. In the semiconductor photoelectrode shown in FIG. 4, a semiconductor thin film 52 of a gallium nitride thin film is formed on a sapphire substrate 51, and an oxidation co-catalyst layer 53 for promoting a reaction is formed on the semiconductor thin film 52 in an island shape.

### CITATION LIST

### Non Patent Literature

Non Patent Literature 1: S. Yotsuhashi, et al., “CO2 Conversion with Light and Water by GaN Photoelectrode”, Japanese Journal of Applied Physics, The Japan Society of Applied Physics, 2012, Volume 51, pp. 02BP07-1-02BP07-3
Non Patent Literature 2: S. H. Kim, et al., “Improved efficiency and stability of GaN photoanode inphotoelectrochemical water splitting by NiO cocatalyst”, Applied Surface Science, Elsevier B. V., 2014, Volume 305, pp. 638-641

### SUMMARY OF THE INVENTION

### Technical Problem

When the gallium nitride thin film of the semiconductor photoelectrode in the related art is irradiated with light in an aqueous solution, an etching reaction of GaN proceeds as a side reaction in addition to the target oxidation reaction of water.

Etching reaction: 2GaN+3H₂O+6h⁺→N₂+Ga₂O₃+6H⁺

The problem is that the light energy conversion efficiency decreases in a few hours because the etching reaction proceeds and the reaction field where the target reaction can proceed decreases.

The present invention has been made in view of the above, and an object of the present invention is to provide a semiconductor photoelectrode that maintains the light energy conversion efficiency for a long time.

### Means for Solving the Problem

The semiconductor photoelectrode according to the present invention includes a conductive substrate including a III-V group compound semiconductor, and a first semiconductor layer disposed on the substrate and including a III-V group compound semiconductor having a photocatalytic function, and an oxygen generation co-catalyst layer disposed on the first semiconductor layer and having an oxygen generation co-catalytic function for the first semiconductor layer.

The semiconductor photoelectrode further includes a second semiconductor layer which is disposed between the first semiconductor layer and the oxygen generation co-catalyst layer, and includes a III-V group compound semiconductor having a lattice constant smaller than a lattice constant of the first semiconductor layer in a plane perpendicular to a crystal growth direction.

### Effects of the Invention

According to the present invention, it is possible to provide a semiconductor photoelectrode that maintains the light energy conversion efficiency for a long time.

### BRIEF DESCRIPTION OF DRAWINGS

FIG. 1 is a cross-sectional view illustrating a partial configuration of a semiconductor photoelectrode of the present embodiment.

FIG. 2 is a cross-sectional view illustrating a partial configuration of another semiconductor photoelectrode of the present embodiment.

FIG. 3 is a diagram illustrating an overview of an apparatus for performing a redox reaction test.

FIG. 4 is a cross-sectional view illustrating a configuration of a semiconductor photoelectrode in the related art.

### DESCRIPTION OF EMBODIMENTS

Embodiments of the present invention will be described with reference to the drawings. The present invention is not limited to the embodiments described below, and changes may be made without departing from the spirit of the present invention.

Configuration of Semiconductor Photoelectrode

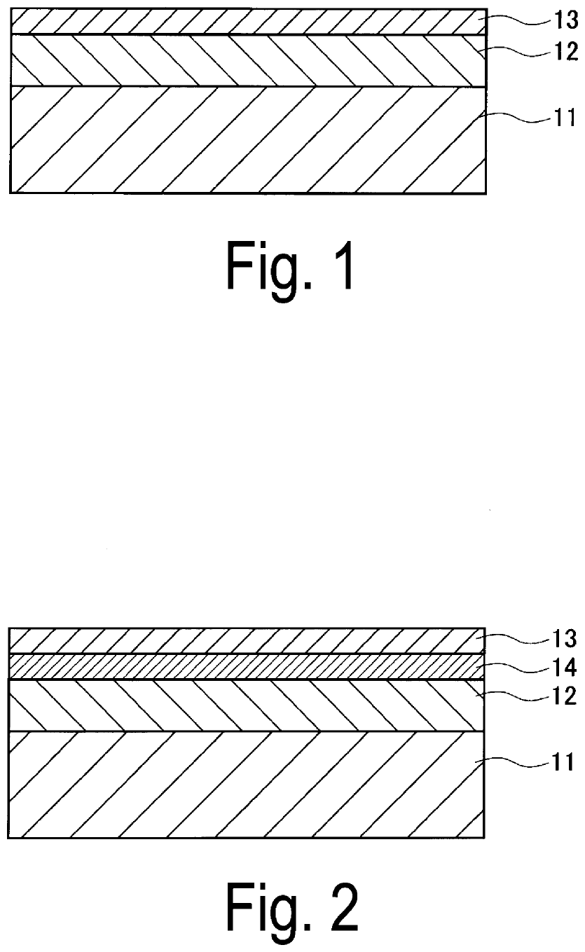

FIG. 1 is a cross-sectional view illustrating a partial configuration of a semiconductor photoelectrode of the present embodiment. The semiconductor photoelectrode illustrated in FIG. 1 includes a substrate 11, a semiconductor thin film 12 having a photocatalytic function, and an oxygen generation co-catalyst layer 13 having an oxygen generation co-catalytic function for the semiconductor thin film 12. The oxygen generation co-catalyst layer 13 has a thickness that allows light to pass through it in an amount that causes the reaction region of the semiconductor thin film 12 causing a reaction of the target substance to exert a catalytic function, and is formed in a film shape so as to cover the reaction region of the semiconductor thin film 12. Irradiation of the surface of the oxygen generation co-catalyst layer 13 with light causes an oxidation reaction of water on the surface.

As the substrate 11, a growth substrate made of a compound of the same family as the semiconductor thin film 12 is used. A semiconductor thin film 12 made of a homologous compound is grown on the conductive substrate 11 made of a III-V Group compound semiconductor. Specifically, a III-V group compound semiconductor such as gallium nitride (GaN), aluminum gallium nitride (AlGaN), or indium gallium nitride (InGaN) is used for the substrate 11 and the semiconductor thin film 12.

A material having a co-catalytic function for the semiconductor thin film 12 is used for the oxygen generation co-catalyst layer 13. The oxygen generation co-catalyst layer 13 may be at least one metal selected from the group consisting of Ni, Co, Cu, W, Ta, Pd, Ru, Fe, Zn, and Nb or an oxide thereof. The film thickness of the oxygen generation co-catalyst layer 13 is from 1 nm to 10 nm. In particular, the thickness is preferably 1 nm to 3 nm, which allows sufficient light transmission.

Furthermore, as illustrated in FIG. 2, between the semiconductor thin film 12 and the oxygen generation co-catalyst layer 13, a semiconductor thin film 14 made of a III-V group compound semiconductor having a lattice constant smaller than a lattice constant of the semiconductor thin film 12 in a plane perpendicular to the crystal growth direction may be provided. The semiconductor thin films 12 and 14 may be a combination of III-V group compound semiconductors such as aluminum gallium nitride (AlGaN) and indium gallium nitride (InGaN).

Production of Semiconductor Photoelectrode

Next, production of the semiconductor photoelectrode in the present embodiment will be described.

### Example 1

As Example 1, production of the semiconductor photoelectrode of FIG. 1 will be described.

An n-type GaN substrate was used as the substrate 11. A semiconductor thin film 12 was formed by epitaxially growing silicon-doped n-type gallium nitride (n-GaN) on a 2-inch n-GaN substrate by a metal organic chemical vapor deposition method. The film thickness of the semiconductor thin film 12 was 2 μm, which is a sufficient thickness to absorb light. The carrier density of the semiconductor thin film 12 formed by this method was 3×10¹⁸ cm⁻³.

A sample in which the semiconductor thin film 12 was formed on the substrate 11 was cleaved into four equal parts, and one of them was used for electrode production.

Ni having a film thickness of about 1 nm was vacuum-deposited on the surface (n-GaN surface) of the semiconductor thin film 12. Thereafter, the sample on which the Ni thin film was deposited was heat-treated in an air atmosphere at 300° C. for 1 hour to oxidize the Ni thin film to form a NiO thin film. TEM observation of the cross section of the sample revealed that the thickness of the NiO thin film was 2 nm. This NiO film was used as the oxygen generation co-catalyst layer 13.

As a method of forming the oxygen generation co-catalyst layer 13, an oxide may be directly formed on the semiconductor thin film 12. The metal oxide film forming method may be a physical vapor deposition method such as a vacuum evaporation method or a sputtering method, a chemical vapor deposition method such as a metal organic vapor phase growth method, or a liquid phase growth method.

Through the above steps, the semiconductor photoelectrode of Example 1 was obtained.

In the redox reaction test described below, a lead was connected to a part of the exposed surface of the semiconductor thin film 12, soldered with indium, and the surface of the indium was covered with an epoxy resin so as not to be exposed. This was installed as the semiconductor photoelectrode of Example 1.

### Example 2

As Example 2, production of the semiconductor photoelectrode of FIG. 2 will be described.

An n-type GaN substrate was used as the substrate 11. On a 2-inch n-GaN substrate, silicon-doped n-type gallium nitride (n-GaN: the lattice constant of the plane parallel to the substrate is 3.189 Å) was epitaxially grown by a metal organic chemical vapor deposition method to form a semiconductor thin film 12. The film thickness of the semiconductor thin film 12 was 2 μm, which is a sufficient thickness to absorb light. The carrier density of the semiconductor thin film 12 formed by this method was 3×10¹⁸ cm⁻³.

Subsequently, aluminum gallium nitride (Al_{0.05}Ga_{0.95}N: the lattice constant of the plane parallel to the substrate is 3.185 Å) with an aluminum composition ratio of 5% was grown on the semiconductor thin film 12 to form the semiconductor thin film 14. The film thickness of the semiconductor thin film 14 was 100 nm, which is sufficient to sufficiently absorb light.

Thereafter, the sample in which the semiconductor thin films 12 and 14 were formed on the substrate 11 was cleaved into four equal parts, and the oxygen generation co-catalyst layer 13 was formed on the semiconductor thin film 14 in the same manner as in Example 1, thus obtaining the semiconductor photoelectrode of Example 2.

In the redox reaction test described below, the surface of the semiconductor thin film 14 was scribed, the semiconductor thin film 12 was exposed, a lead was connected to a part of the exposed surface of the semiconductor thin film 12 and soldered with indium, and the surface of the indium was covered with an epoxy resin so as not to be exposed. This was installed as the semiconductor photoelectrode of Example 2.

Redox Reaction Test

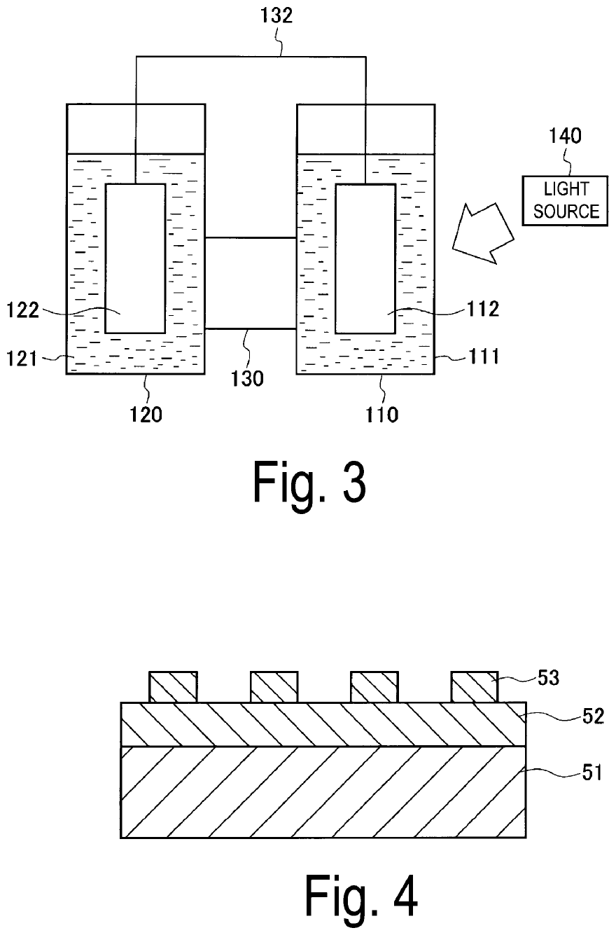

Next, a redox reaction test using the apparatus of FIG. 3 will be described.

The apparatus of FIG. 3 includes an oxidation tank 110 and a reduction tank 120. An aqueous solution 111 is put in the oxidation tank 110, and an oxidation electrode 112 is put in the aqueous solution 111. In the reduction tank 120, an aqueous solution 121 is placed, and the reduction electrode 122 is placed in the aqueous solution 121.

As the aqueous solution 111 in the oxidation tank 110, a 1 mol/L sodium hydroxide aqueous solution was used. As the aqueous solution 111, an aqueous potassium hydroxide solution or hydrochloric acid may be used.

A semiconductor photoelectrode to be tested is used as the oxidation electrode 112. Specifically, as the oxidation electrode 112, the semiconductor photoelectrodes of Examples 1 and 2 described above and the semiconductor photoelectrodes of Comparative Examples 1 and 2 described later are used.

As the aqueous solution 121 in the reduction tank 120, a 0.5 mol/L potassium hydrogen carbonate aqueous solution was used. As the aqueous solution 121, an aqueous solution of sodium hydrogen carbonate, an aqueous solution of potassium chloride, or an aqueous solution of sodium chloride may be used.

Platinum (manufactured by The Nilaco Corporation) was used for the reduction electrode 122. The reduction electrode 122 may be a metal or a metal compound. As the reduction electrode 122, for example, nickel, iron, gold, platinum, silver, copper, indium, or titanium may be used.

The oxidation tank 110 and the reduction tank 120 are connected via a proton membrane 130. The protons generated in the oxidation tank 110 diffuse into the reduction tank 120 through the proton membrane 130. Nafion (trade name) was used for the proton membrane 130. Nafion is a perfluorocarbon material composed of a hydrophobic Teflon skeleton that is carbon-fluorine based and a perfluoro side chain having a sulfonic acid group.

The oxidation electrode 112 and the reduction electrode 122 are electrically connected by a lead 132, and electrons move from the oxidation electrode 112 to the reduction electrode 122.

As the light source 140, a 300 W high-pressure xenon lamp (illuminance: 5 mW/cm²) was used. The light source 140 only needs to be able to emit light having a wavelength that can be absorbed by the material composing the semiconductor photoelectrode provided as the oxidation electrode 112. For example, when the oxidation electrode 112 is composed of gallium nitride, the wavelength that can be absorbed by the oxidation electrode 112 is 365 nm or less. As the light source 140, a light source such as a xenon lamp, a mercury lamp, a halogen lamp, a pseudo solar source, or sunlight may be used, or these light sources may be combined.

In the redox reaction test, nitrogen gas was passed at 10 mL/min in each reaction tank, the light irradiation area of the sample was set to 1 cm², and the aqueous solutions 111 and 121 were stirred at the center position of the bottom of each reaction tank at a rotation speed of 250 rpm using a stirring bar and a stirrer.

After the inside of the reaction tank was sufficiently replaced with nitrogen gas, the light source 140 was fixed so as to face the surface on which the oxidation co-catalyst of the semiconductor photoelectrode to be tested, which had been installed as the oxidation electrode 112, was formed, and the semiconductor photoelectrode was uniformly irradiated with light.

The gas in each reaction tank was sampled at any time during light irradiation, and the reaction product was analyzed by a gas chromatograph. As a result, it was confirmed that oxygen was generated in the oxidation tank 110 and hydrogen was generated in the reduction tank 120.

Test Results

A redox reaction test was conducted using the semiconductor photoelectrodes of Examples 1 and 2 and the semiconductor photoelectrodes of Comparative Examples 1 and 2 as the oxidation electrode 112 of the apparatus of FIG. 3. Comparative Examples 1 and 2 use a sapphire substrate as the substrate 11 of the semiconductor photoelectrodes of Examples 1 and 2. In other respects, Comparative Example 1 was the same as Example 1, and Comparative Example 2 was the same as Example 2.

Table 1 shows the crystallinity of the samples in Examples 1 and 2 and Comparative Examples 1 to 4.

TABLE 1

Dislocation density/cm⁻²

| Examples | (002) | (102) |
|---|---|---|
| Example 1 | 8 × 10⁷ | 7 × 10⁸ |
| Example 2 | 8 × 10⁷ | 7 × 10⁸ |
| Comparative Example 1 | 3 × 10⁸ | 6 × 10⁹ |
| Comparative Example 2 | 3 × 10⁸ | 6 × 10⁹ |

It was found that the dislocation densities of the semiconductor photocatalyst thin films of Examples 1 and 2 using the n-GaN substrate were lower than the dislocation density of the semiconductor photocatalyst thin film using the sapphire substrate. In particular, the dislocation density of (102) was reduced by one digit, indicating that Examples 1 and 2 have excellent crystallinity as compared with Comparative Examples 1 and 2.

Table 2 shows the amounts of oxygen/hydrogen gas generated with respect to the light irradiation time in Examples 1 and 2 and Comparative Examples 1 to 4.

TABLE 2

| | Amount of gas generated in cell/μmol- cm⁻²-h⁻¹ | | | | | | | |
|---|---|---|---|---|---|---|---|---|
| | Immediately after | | 50 hours after | | 100 hours after | | 150 hours after | |
| | light irradiation | | light irradiation | | light irradiation | | light irradiation | |
| Examples | Oxygen | Hydrogen | Oxygen | Hydrogen | Oxygen | Hydrogen | Oxygen | Hydrogen |
| Example 1 | 25.0 | 50.1 | 23.7 | 47.5 | 22.5 | 45.3 | 21.1 | 42.3 |
| Example 2 | 91.1 | 180 | 85.4 | 171 | 81.1 | 162 | 76.3 | 152 |
| Comparative | 23.5 | 46.2 | 21.3 | 42.8 | 19.7 | 39.1 | 11.4 | 30.2 |
| Example 1 | | | | | | | | |
| Comparative | 88.7 | 175 | 80.4 | 162 | 74.6 | 149 | 42.1 | 114 |
| Example 2 | | | | | | | | |

The generated amount of each gas was normalized by the surface area of the semiconductor photoelectrode. It was found that oxygen and hydrogen were generated upon irradiation with light in all examples.

Comparing the amounts of oxygen and hydrogen generated in Example 1 and Comparative Example 1, although there was no great difference in the generation amount immediately after the light irradiation, a difference was observed in the generated amounts as time passed from the start of the light irradiation. 100 hours after the light irradiation, the generated amounts of oxygen and hydrogen in Example 1 was reduced by about 10%, while the generated amounts of oxygen and hydrogen in Comparative Example 1 was reduced by about 15%. In addition, 150 hours after the light irradiation, the amount of oxygen and hydrogen generated in Example 1 was reduced by 15%, while in Comparative Example 1, the amount of hydrogen generated was reduced by 35% and the amount of oxygen generated was reduced by 50%. In the case of Comparative Example 1, in addition to the large decrease in the generated amount, the generated amounts of oxygen and hydrogen were not 1:2, so that the hydrogen generation by the side reaction (etching reaction) on the semiconductor electrode surface was considered remarkable. These phenomena were the same when Example 2 was compared with Comparative Example 2.

From the above, a semiconductor photoelectrode having a reduced dislocation density using an n-GaN substrate can maintain the generated amounts of hydrogen and oxygen (light energy conversion efficiency) by water splitting reaction. It was found that the dislocation density of the semiconductor photocatalyst thin film is preferably 10⁸ cm⁻² and 10⁹ cm⁻² or less for (002) and (102), respectively.

As described above, according to the present embodiment, in a semiconductor photoelectrode, using a conductive substrate 11 including a III-V group compound semiconductor, a semiconductor thin film 12 including a III-V group compound semiconductor having a photocatalytic function is disposed on the substrate 11, and an oxygen generation co-catalyst layer 13 having an oxygen generation co-catalytic function for the semiconductor thin film 12 is disposed on the semiconductor thin film 12, thereby providing a semiconductor photoelectrode capable of improving the crystallinity of the semiconductor photocatalyst thin film and maintaining the light energy conversion efficiency of the semiconductor photoelectrode for a long time.

In this embodiment, the target product was hydrogen. Alternatively, it is also possible to generate a carbon compound by the reduction reaction of carbon dioxide, or ammonia by the reduction reaction of nitrogen by changing the reduction electrode 122 to, for example, Ni, Fe, Au, Pt, Ag, Cu, In, Ti, Co, or Ru.

### REFERENCE SIGNS LIST

11 substrate
12, 14 semiconductor thin film
13 oxygen generation co-catalyst layer
110 oxidation tank
111 aqueous solution
112 oxidation electrode
120 reduction tank
121 aqueous solution
122 reduction electrode
130 proton membrane
132 lead
140 light source
51 sapphire substrate
52 semiconductor thin film
53 oxidation co-catalyst layer

1. A semiconductor photoelectrode comprising:
a conductive substrate comprising a III-V group compound semiconductor;
a first semiconductor layer disposed on the substrate and comprising a III-V group compound semiconductor having a photocatalytic function; and;
an oxygen generation co-catalyst layer disposed on the first semiconductor layer and having an oxygen generation co-catalytic function for the first semiconductor layer.

2. The semiconductor photoelectrode according to claim 1, further comprising a second semiconductor layer which is disposed between the first semiconductor layer and the oxygen generation co-catalyst layer and includes a III-V group compound semiconductor having a lattice constant smaller than a lattice constant of the first semiconductor layer in a plane perpendicular to a crystal growth direction.

3. The semiconductor photoelectrode according to claim 1, wherein the substrate and the first semiconductor layer are n-type semiconductors.

4. The semiconductor photoelectrode according to claim 2, wherein the substrate and the first semiconductor layer are n-type semiconductors.
